(19) United States
(12) Patent Application Publication
(10) Pub. No.: US 2011/0102813 A1
(43) Pub. Date: May 5, 2011

(54) MOVEMENT DETECTION APPARATUS, MOVEMENT DETECTION METHOD, AND RECORDING APPARATUS

(75) Inventors: Masashi Hayashi, Kawasaki-shi (JP); Hitoshi Nishikori, Inagi-shi (JP)

(73) Assignee: CANON KABUSHIKI KAISHA, Tokyo (JP)

(21) Appl. No.: 12/911,571

(22) Filed: Oct. 25, 2010

(30) Foreign Application Priority Data
Oct. 30, 2009 (JP) 2009-250828

(51) Int. Cl. G06K 15/02

(52) U.S. Cl. 358/1.5

(57) ABSTRACT

A movement detection apparatus acquires a displacement direction and an amount of displacement of a template region in the first image data that is displaced in the second image data in a direction orthogonal to a direction of a movement of an object. Based on the acquired displacement direction and the amount of displacement, a position at which the template pattern is clipped in the direction is set.

### BACKGROUND OF THE INVENTION

1. Field of the Invention

The present invention relates to a technique for detecting a movement of an object by image processing, and a technical field of a recording apparatus.

2. Description of the Related Art

When printing is performed while a medium such as a print sheet is being conveyed, if conveyance accuracy is low, density unevenness of a halftone image or a magnification error may be generated, thereby deteriorating quality of print images.

Therefore, although high-performance components are adopted and an accurate conveyance mechanism is mounted, requests about print qualities are demanding, and further enhancement of accuracy is requested. In addition, requests about costs are also demanding. Both of high accuracy and low costs are requested.

To address these issues, and thus, to detect a movement of a medium with high accuracy and perform stable conveyance by a feedback control, it has been attempted to capture the image of a surface of the medium and detect the movement of the medium that is being conveyed, by image processing.

Japanese Patent Application Laid-Open No. 2007-217176 discusses a method for detecting the movement of the medium. According to Japanese Patent Application Laid-Open No. 2007-217176, an image of a surface of a moving medium is captured by using an image sensor several times in time series, pieces of the acquired image data are compared with each other by performing pattern matching processing, and thus an amount of the movement of the medium can be detected. Hereinafter, a method in which a movement state is detected by directly detecting the surface of the object is referred to as “direct sensing”, and a detector used for this method is referred to as a “direct sensor”.

The image sensor used as the direct sensor typically includes an imaging surface including an array of two-dimensional light receiving elements having a rectangular shape. The image sensor is located in such a manner that a longer direction of the rectangular shape of the direct sensor corresponds to a direction for measuring the movement (conveyance direction of the object).

However, along with poor accuracy and changes of the apparatus across the ages, as illustrated in FIG. 8, the image sensor 302 can be slanted with respective to the conveyance direction (“y” direction) of the object. FIG. 10C illustrates a state, which can occur when the issue described above arises.

A part of a region or an entire region of a template pattern (template region) in a first image data can be located out of a region where the image sensor captures images in a second image data to be subsequently acquired. In this case, when a same pattern as the template pattern is sought in the second image data, a matching pattern cannot be detected, thereby resulting in a detection fault.

Although the image sensor is mounted correctly, when an oblique conveyance (the object is conveyed in an oblique direction with respect to an original conveyance direction) occurs, similarly, the template region in the first image data can be located out of the region in the second image data.

In other words, if at least one of the mount direction of the image sensor and the movement direction of the object deviates from the original direction, a relative relationship between the both directions described above may cause a deviation, thereby causing the above-described issue.

### SUMMARY OF THE INVENTION

According to an aspect of the present invention, an apparatus includes a sensor configured to capture an image of a surface of an object that moves in a predetermined direction and acquire first and second data, and a processing unit configured to acquire a movement state of the object by taking away a template pattern in a template region set in the first data and seeking a region having a correlation with the template pattern in the second data. The processing unit acquires displacement information about a displacement of the template region in the first data that is displaced in the second data in a first direction and in a second direction orthogonal to the first direction corresponding to the predetermined direction on image coordinates, and based on the acquired displacement information, a position of the template region is set in the second direction.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a vertical cross sectional view of a printer according to an exemplary embodiment of the present invention.

FIG. 2 is a vertical cross sectional view of a modified printer.

FIG. 3 is a system block diagram of the printer.

FIG. 4 illustrates a configuration of a direct sensor.

FIG. 5 is a flowchart illustrating an operation sequence of feeding, recording, and discharging a medium.

FIG. 6 is a flowchart illustrating an operation sequence of conveying the medium.

FIG. 7 illustrates processing for acquiring an amount of movement by using pattern matching.

FIG. 8 illustrates a positional relationship between a direct sensor and a conveyance belt.

FIGS. 9A and 9B each illustrate a relationship between image data and a template pattern.

FIGS. 10A, 10B, and 10C illustrate a procedure for re-setting the template pattern.

FIG. 11 is a flowchart illustrating a sequence for setting a template position.

FIG. 12 illustrates an arrangement relationship between image sensors in a double-lens direct sensor.

FIG. 13 illustrates positions after a right template pattern and a left template pattern have been moved.

FIG. 14 is a flowchart illustrating a sequence for setting positions of templates.

### DESCRIPTION OF THE EMBODIMENTS

Various exemplary embodiments, features, and aspects of the invention will be described in detail below with reference to the drawings.

However, configuration elements described in the exemplary embodiments are merely one of the examples and not intended to limit a scope of the present invention.

A range, including printers, to which the present invention is applied, widely covers a field of movement detection, where detection of the movement of an object with high accuracy is requested. For example, the present invention can be applied to devices such as printers and scanners, and also devices used in a manufacturing field, an industrial field, and a distribution field where various types of processing such as examination, reading, processing, and marking is performed while the object is being conveyed.

Further, the present invention can be applied to various types of printers, such as an ink-jet method, an electro-photographic method, a thermal method, and a dot impact method.

In this specification, a “medium” refers to a medium having a sheet-like shape or a plate-like shape medium made of paper, plastic sheet, film, glass, ceramic, or resin. In addition, an upstream and a downstream described in this specification are defined based on a conveyance direction of a sheet while image recording is being performed on the sheet.

An exemplary embodiment of the printer of the ink-jet method, which is an example of the recording apparatuses, will be described. The printer of the present exemplary embodiment is a serial printer, in which a reciprocating movement (main scanning) of a printer head and step feeding of a medium by a predetermined amount are alternately performed to form a two-dimensional image.

The present invention can be applied not only to the serial printer but also to a line printer including a long line print head for covering a print width, in which the medium moves with respect to the fixed print head to form the two-dimensional image.

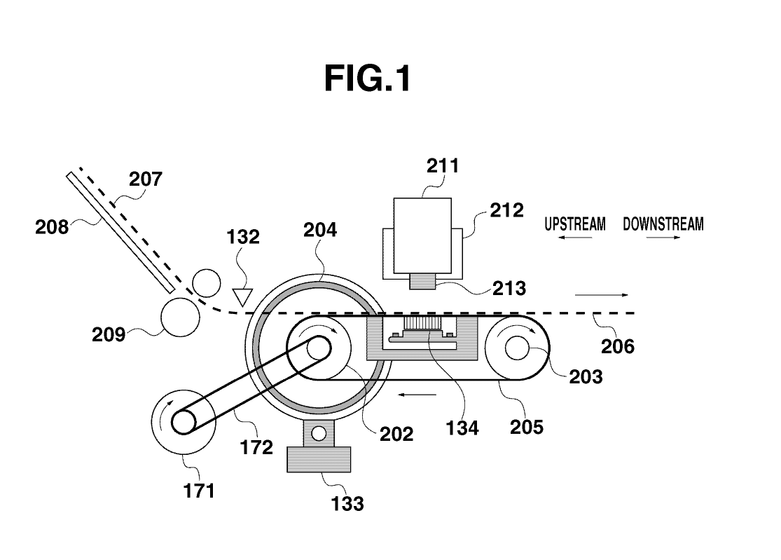

FIG. 1 is a vertical cross sectional view illustrating a configuration of main part of the printer. The printer includes a conveyance mechanism that causes a belt conveyance system to moves the medium in a sub scanning direction (first direction or predetermined direction) and a recording unit that performs recording on the moving medium using the print head. The printer further includes an encoder 133 that indirectly detects a movement state of the object and a direct sensor 134 that directly detects the movement state thereof.

The conveyance mechanism includes a first roller 202 and a second roller 203, which are rotating members, and a wide conveyance belt 205 stretched around the rollers 202 and 203 with a predetermined tension. A medium 206 is attracted to a surface of the conveyance belt 205 with an electrostatic force or adhesion, and conveyed along with the movement of the conveyance belt 205.

A rotating force generated by a conveyance motor 171, which is a driving force of sub scanning, is transmitted to the first roller 202, which is a driving roller, via a driving belt 172 to rotate the first roller 202. The first roller 202 and the second roller 203 rotate in synchronization with each other via conveyance belt 205.

The conveyance mechanism further includes a feeding roller 209 for separating each one of the media 207 stored on a tray 208, and feeding the medium 207 onto a conveyance belt 205, and a feeding motor 161 (not illustrated in FIG. 1) for driving the feeding roller 209. A paper end sensor 132 provided at a downstream of the feeding motor 161 detects a front end or a rear end of the medium to acquire timing for conveying the medium.

The encoder 133 (rotation angle sensor) of a rotary type detects a rotation state of the first roller 202 and indirectly acquires a movement state of the conveyance belt 205. The encoder 133 includes a photo interrupter, and optically reads slits carved at equal intervals along a periphery of a code wheel 204 provided about a same axis as that of the first roller 202 to generate pulse signals.

A direct sensor 134 is disposed beneath the conveyance belt 205 (at a rear side opposite to a side on which the medium 206 is placed). The direct sensor 134 includes an image sensor (imaging device) that captures an image of a region including a marker marked on the surface of the conveyance belt 205.

The direct sensor 134 directly detects the movement state of the conveyance belt 205 by image processing described below. Since the surface of the conveyance belt 205 and that of the medium 206 are firmly adhered to each other, a relative position change caused by slipping between the surfaces of the belt and the medium is small enough to be ignored. Therefore, the direct sensor 134 can be regarded as performing the detection, which is equivalent to directly detecting the movement state of the medium 206.

The direct sensor 134 is not limited to the configuration in which the rear surface of the conveyance belt 205 is captured, but the direct sensor 134 may capture the image of a front surface of the conveyance belt 205 that is not covered with the medium 206. Further, the direct sensor 134 may capture the image of the surface of the medium 206 not the surface of the conveyance belt 205, as the object.

A recording unit includes a carriage 212 that reciprocately moves in a main scanning direction, and a print head 213 and an ink tank 211 that are mounted in the carriage 212. The carriage 212 reciprocately moves in the main scanning direction (second direction) by a driving force of a main scanning motor 151 (not illustrated in FIG. 1).

Ink is discharged from nozzles of the print head 213 in synchronization with the movement described above to perform printing on the medium 206. The print head 213 and the ink tank 211 may be unified to be attachable to and detachable from the carriage 212, or may be individually attachable to and detachable from the carriage 212 as separate components.

The print head 213 discharges the ink by using the ink-jet method. The method can adopt heater elements, piezoelectric elements, static elements, and micro electro mechanical system (MEMS) devices.

The conveyance mechanism is not limited to the belt conveyance system, but, as a modification example, may adopt a mechanism for causing the conveyance roller to convey the medium without using the conveyance belt.

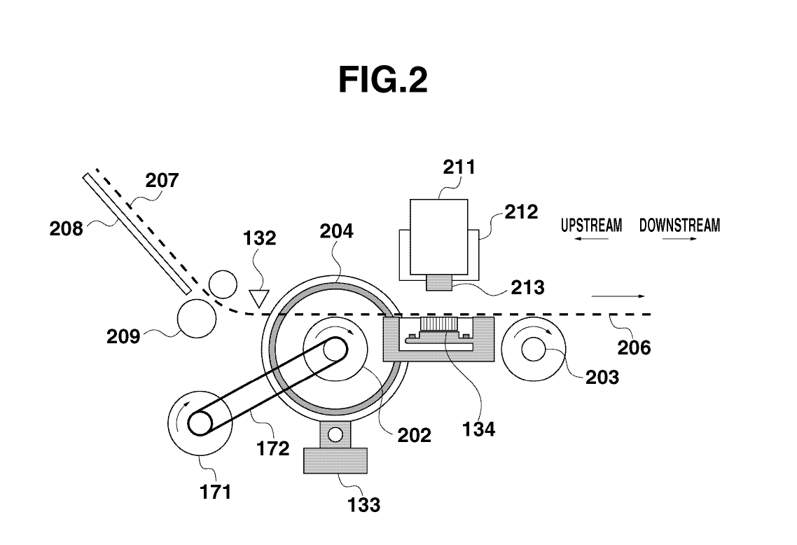

FIG. 2 illustrates a vertical cross sectional view of a printer of a modification example. Same numerals are given to the same members as those in FIG. 1.

Each of the first roller 202 and the second roller 203 directly contact with the medium 206 and moves the medium 206. A synchronization belt (not illustrated) is stretched around the first roller 202 and the second roller 203, so that the second roller 203 rotates in synchronization with a rotation of the first roller 202.

According to the present exemplary embodiment, the object whose image is captured by the direct sensor 134 is not the conveyance belt 205 but the medium 206. The direct sensor 134 captures the image of the rear surface side of the medium 206.

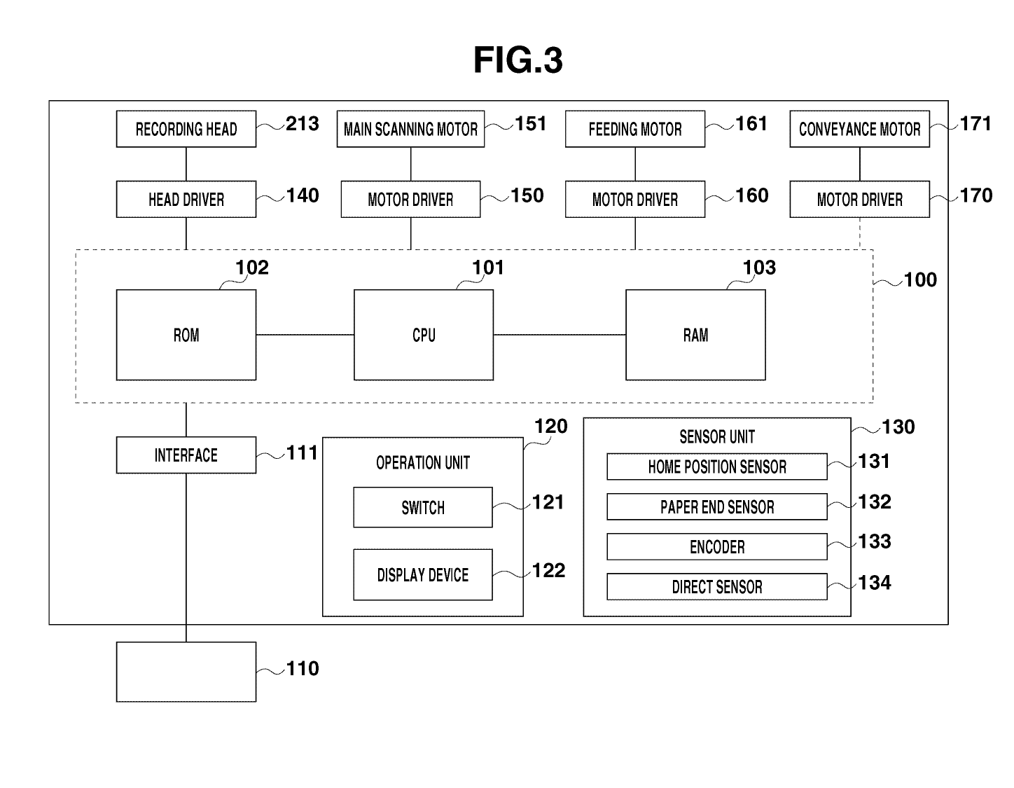

FIG. 3 is a system block diagram of the printer. The controller 100 includes a central processing unit (CPU) 101, a read only memory (ROM) 102, and a random access memory (RAM) 103. The controller 100 works as both of a control unit and a processing unit that deal with various types of controls and image processing in an entire printer.

An information processing apparatus 110 may be a computer, digital camera, television set (TV), and mobile phone, and supplies image data to be recorded on the medium. The information processing apparatus 110 is connected to the controller 100 via an interface 111. An operation unit 120 serves as a user interface between the apparatus and an operator, and includes various types of input switches 121 including a power source switch, and a display device 122.

A sensor unit 130 is a group of sensors that detect various types of states of the printer. A home position sensor 131 detects a home position of the carriage 212 that reciprocately moves. The sensor unit 130 includes a paper end sensor 132 described above, the encoder 133, and the direct sensor 134. Each of these sensors is connected to the controller 100.

Based on instructions of the controller 100, the printer head or various types of motors of the printer are driven via drivers. A head driver 140 drives the print head 213 according to recording data.

A motor driver 150 drives a main scanning motor 151. A motor driver 160 drives a feeding motor 161. A motor driver 170 drives a conveyance motor 171 for sub scanning.

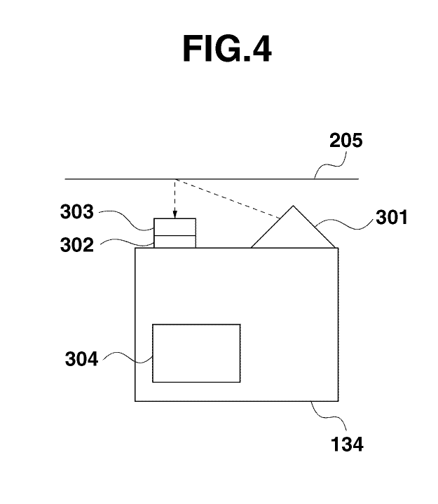

FIG. 4 illustrates a configuration of a direct sensor 134 for performing direct sensing. The direct sensor 134 serves as a sensor unit that includes a light emitting unit including a light source 301 of light emitting diode (LED), organic light emitting diode (OLED), and semi conductor laser, a light receiving unit including an image sensor 302 and a refractive index distribution array 303, and a circuit unit 304 including a drive circuit and an analog/digital (A/D) convertor circuit.

The light source 301 irradiates a part of the rear surface side of the conveyance belt 205, which is an imaging target. The image sensor 302 captures an image of a predetermined imaging region irradiated via the refractive index distribution array 303. The image sensor 302 is a two-dimensional area sensor or a line sensor such as a charge coupled device (CCD) image sensor or a complementary metal-oxide semiconductor (CMOS) image sensor.

Signals output from the image sensor 302 are A/D converted and taken in as digital image data. The image sensor 302 captures the image of the surface of the object (conveyance belt 205), and acquire a plurality of image data (pieces of sequentially acquired data are referred to as “first image data” and “second image data”) at different timing.

As described below, the movement state of the object can be acquired by clipping the template pattern from the first image data and, in the second image data, seeking a region having a high correlation with the acquired template pattern by the image processing.

The controller 100 may serve as the processing unit for performing the image processing, or the processing unit may be built in a unit of the direct sensor 134.

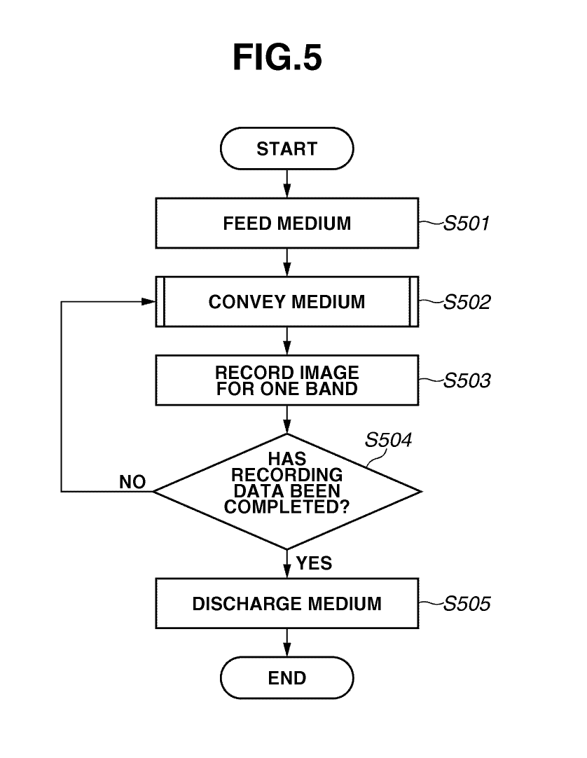

FIG. 5 is a flowchart illustrating a series of operation sequences for feeding, recording, and discharging. These operation sequences are performed based on the instructions given by the controller 100.

In step S501, the feeding motor 161 is driven to cause the feeding roller 209 to separate off each one of the media 207 stored on the tray 208 and to feed the medium 207 along a conveyance path. When the paper end sensor 132 detects a leading end of the medium 206 that is being fed, based on the detection timing, a cuing operation is performed on the medium 206, and then the medium 206 is conveyed to a predetermined recording starting position.

In step S502, the medium 206 is step-fed by a predetermined amount using the conveyance belt 205. The predetermined amount refers to a length of recording performed in one band (one main scanning performed by the printer head) in the sub scanning direction.

For example, when a multi path recording is performed by feeding the medium 206 by a half of a width of a nozzle array in the sub scanning direction of the print head 213 and superposing the images each recorded two times, the predetermined amount is a length of a half width of the nozzle array in the sub scanning direction.

In step S503, the image for one band is recorded while the carriage 212 is moving the print head 213 in the main scanning direction. In step S504, it is determined whether recording has been performed on all recording data. When there is the recording data that has not been recorded yet (NO in step S504), the processing returns to step S502 and performs the step-feeding in the sub scanning direction and the recording for one band in the main scanning direction again. When the recording has been completed (YES in step S504) on all recording data, the processing proceeds to step S505.

In step S505, the medium 206 is discharged from the recording unit. As described above, a two-dimensional image is formed on the medium 206.

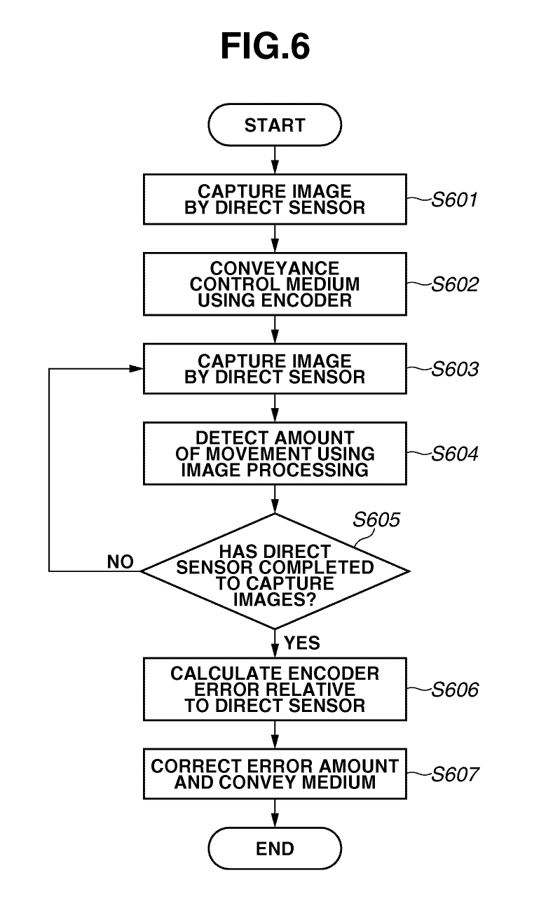

With reference to a flowchart illustrated in FIG. 6, an operation sequence of step-feeding performed in step S502 will be described in detail.

In step S601, the image sensor of the direct sensor 134 captures an image of the region of the conveyance belt 205 including the marker. The acquired image data indicates a position of the conveyance belt before the movement has been started, and is stored in the RAM 103.

In step S602, while the encoder 133 is monitoring the rotation state of the first roller 202, the conveyance motor 171 is driven to move the conveyance belt 205, in other words, conveyance control of the medium 206 is started. The controller 100 performs servo-control to convey the medium 206 by a target amount of conveyance. Under the conveyance control using the encoder, the processing subsequent to step S603 is executed.

In step S603, the direct sensor 134 captures the image of the belt. The image is captured when it is estimated that a predetermined amount of medium has been conveyed. The predetermined amount of medium is determined by the amount of the medium to be conveyed for one band (hereinafter, referred to as “target amount of conveyance”), a width of the image sensor in the first direction, and a conveyance speed.

According to the present exemplary embodiment, a specific slit on the code wheel 204 to be detected by the encoder 133, when the medium has been conveyed by the predetermined amount, is specified. When the encoder 133 detects the slit, capturing the imaging is started. Further detail in step S603 will be described below.

In step S604, by the image processing, what distance the conveyance belt has been moved between the second image data captured in step S603, which is immediately before step S604, and the first image data, which is captured previous to the second image data by one, is detected. Details of processing for detecting the amount of movement will be described below. The images are captured the predetermined number of times at a predetermined interval according to the target amount of conveyance.

In step S605, it is determined whether the predetermined number of times of images have been captured. When the predetermined number of times of images is not captured (NO in step S605), the processing returns to step S603 to repeat the processing until the predetermined number of times of the images are captured.

The amount of conveyance is accumulated every time the amount of conveyance is repeatedly detected by the predetermined number of times. The amount of conveyance for one band is then acquired from the timing when the image is first captured in step S601.

In step S606, an amount of difference for one band between the amount of conveyance acquired by the direct sensor 134 and that by the encoder 133, is calculated. The encoder 133 indirectly detects the amount of conveyance, and thus accuracy of indirect detection of the amount of conveyance performed by the encoder 133 is lower than that of direct detection thereof performed by the direct sensor 134. Therefore, the amount of difference described above can be regarded as a detection error of the encoder 133.

In step S607, correction is given to the conveyance control by the amount of the encoder error acquired in step S606. The correction includes a method for correcting information about a current position under the conveyance control by increasing/decreasing by the amount of error, and a method for correcting the target amount of conveyance by the error amount. Any one of the methods may be adopted. As described above, the medium 206 is correctly conveyed until the target amount of the medium 26 is achieved by the feedback control, and then the conveyance amount for one band is completed.

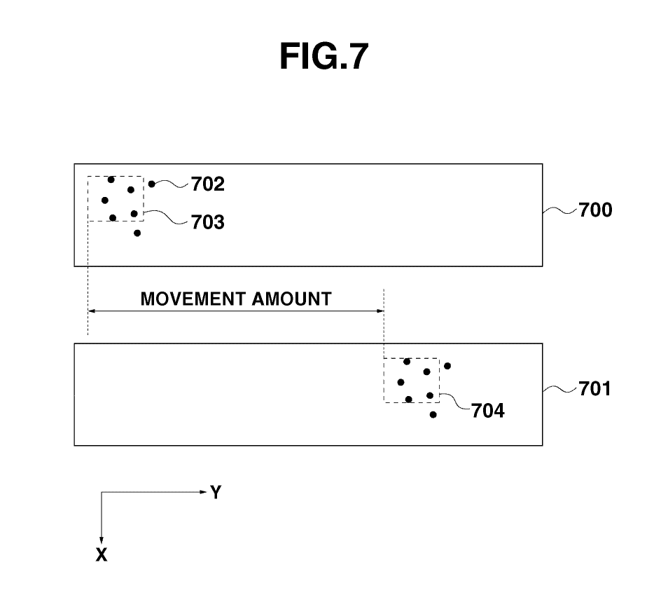

FIG. 7 illustrates details of processing performed in step S604 described above. First image data 700 of the conveyance belt 205 and second image data 701 thereof acquired by capturing the images by the direct sensor 134 are schematically illustrated.

A number of patterns 702 (part having gradation difference between brightness and darkness) indicated with black points in the first image data 700 and the second image data 701 are formed of a number of images of markers applied on the conveyance belt 205 randomly or based on a predetermined rule. Similar to an apparatus illustrated in FIG. 2, when the object is the medium, microscopic patterns (e.g., pattern of paper fibers) on the surface of the medium similarly serve as patterns given on the conveyance belt 205.

For the first image data 700, a template pattern 703 is set in a predetermined template region located on an upstream side, and the image of this part is clipped. A method for setting the template pattern will be described below.

When the second image data 701 is acquired, where a clipped pattern similar to the template pattern 703 is located in the second image data 701 is searched. The search is performed by the pattern matching method. As an algorithm for determining similarity, Sum of Squared Difference (SSD), Sum of Absolute Difference (SAD), Normalized Cross-Correlation (NCC) are known, and any of those may be adopted.

In this example, the most similar pattern is located in a region 704. A difference between the number of pixels on the imaging device of the template pattern 703 in the first image data 700 and that of the region 704 in the second image data 701, in the sub scanning direction, is acquired. By multiplying the difference between the numbers of pixels described above by a distance corresponding to one pixel, the amount of the movement (amount of conveyance) can be acquired.

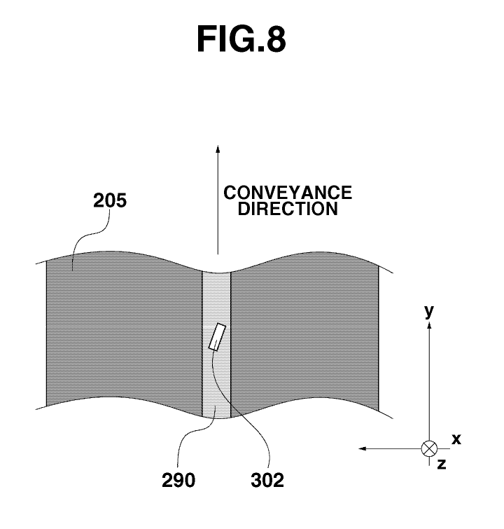

FIG. 8 schematically illustrates an inside of the conveyance belt 205 and is illustrated by clipping a part of an endless belt. A region that is located inside the belt and faces the image sensor includes a group of markers 290, which can be optically identified, at all circumference of the belt along the conveyance direction (“y” direction).

According to the present exemplary embodiment, the group of markers 290 is located in a limited region that includes a center of an imaging plane in a belt width direction (“x” direction). The group of markers 290 includes a number of markers that are given randomly or based on a predetermined rule. The group of markers 290 is formed by drawing with paint, attaching patterning seals, applying physical concavo-convex shape by surface processing, and laser marking.

The longer direction of an imaging surface of the image sensor 302 having the rectangular shape built in the direct sensor 134 is slightly slanted with respect to the conveyance direction (“y” direction) of the conveyance belt 205. A relative difference between both directions described above is thus generated.

This slant is generated depending on accuracy of mounting the direct sensor 134 to the apparatus or that of the image sensor 302 mounted inside the unit of the direct sensor 134. Further, even the direction of the image sensor 302 is correct, when the conveyance direction of the conveyance belt 205 becomes slanted with respect to an original direction (“y” direction) depending on the accuracy of the conveyance mechanism, a relative direction difference between the conveyance directions and the image sensor 302 is generated. In FIG. 8, the slant is illustrated exaggeratingly for easy understanding.

When such a slant is generated, the phenomenon described above occurs. The present exemplary embodiment is to solve this issue by an operation of calibration for appropriately setting a position of the template region by a procedure described below.

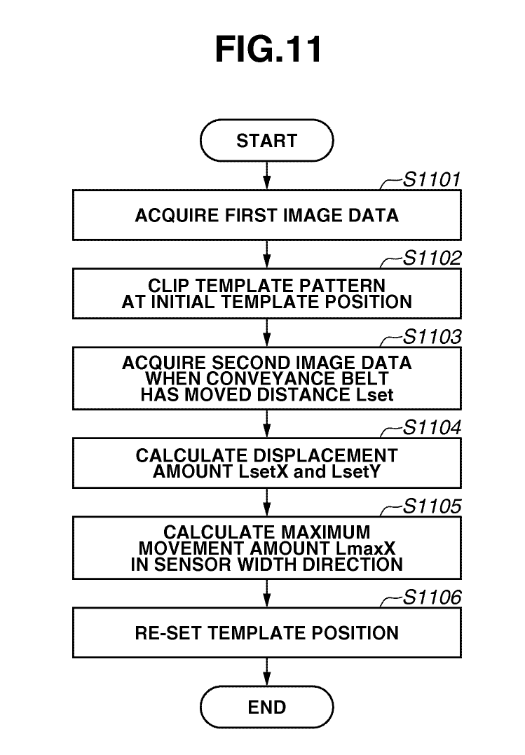

FIG. 11 is a flowchart illustrating a sequence for setting the position of the template region (hereinafter, referred to as a “template position”). When the calibration is automatically operated, this processing is performed in step S604 illustrated in FIG. 6 described above.

During a calibration operation, the conveyance belt 205 moves at a predetermined speed “V” (in this example, 10 mm/s), which is the same speed as that when recording is actually performed. In step S1101, the image sensor 302 captures the image of the region of the group of markers 290 formed inside the conveyance belt 205 to acquire the first image data.

In step S1102, in the template region located at a position set as a default or set by a previous calibration (initial template position), the template pattern is clipped from the first image data.

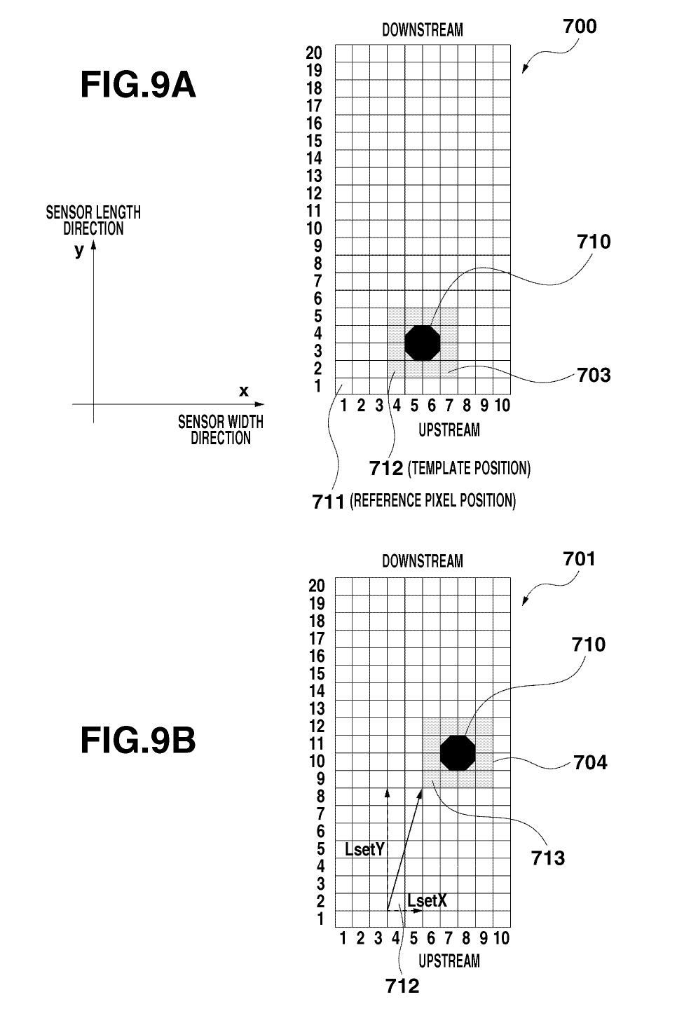

FIG. 9A illustrates the template pattern 703 set at an initial template position in the first image data 700. An initial template position 712 is set so that the set template pattern 703 is located at the center of the imaging plane in a sensor width direction.

The image sensor 302 generates image data having 10 pixels in the sensor width direction (a short side direction of the rectangular) corresponding to an “X” direction and 20 pixels in the sensor length direction (a long side direction of the rectangular, referred to as a “second direction”) corresponding to “Y” direction, which sum up total 200 pixels. One pixel corresponds to 20 μm×20 μm on the object.

According to this specification, in the image coordinates of the image sensor, a direction corresponding to the “y” direction (sub scanning direction) is defined as a “first direction”, and a direction corresponding to the “X” direction (main scanning direction) is defined to as a “second direction”. The image coordinates are a coordinate system of pixels of the image data generated by the image sensor.

According to the present exemplary embodiment, the “x” direction and the “y” direction are orthogonal to each other, and the first direction and the second direction of the image coordinates are also orthogonal to each other. The relationship between the directions is not limited to be orthogonal, but may cross each other not being orthogonal.

An initial template position 712 is four pixels in the second direction and two pixels in the first direction (pixel coordinates (4, 2)) away from a reference pixel position 711 indicated by pixel coordinates (1, 1). The region that has the initial template position 712 as a reference (left bottom) and four×four pixels in length and width is set as the template pattern 703, and the image data thereof is clipped. In this example, the template pattern 703 includes a characteristic design 710 included in the group of markers 290.

The design 710 is schematically illustrated for description. The design 710 may be one figure having a free shape included in the group of markers 290 or a plurality of dots as illustrated in FIG. 7.

In step S1103, the amount of movement of the conveyance belt 205 is monitored by detection performed by the encoder 133. When the object is conveyed the distance Lset (0.140 mm in this example) since the first image data has been acquired, the image sensor acquires the second image data.

FIG. 9B illustrates the second image data 701. The coordinates of the initial template position 712 are moved to coordinates 713, and the design 710 included in the template pattern 703 in the first image data 700 is also displaced by the same vector components. In this example, the design 710 is moved two pixels in the second direction and seven pixels in the first direction.

In step S1104, in the second image data 701, a region having a high correlation with the template pattern 703 is sought. The algorithm is as previously described in FIG. 7.

As a result of seeking, it is calculated that the template pattern 703 has been displaced by LsetX in the second direction and LsetY in the first direction. In this example, the LsetX is calculated as two pixels (equivalent to 40 μm) and the LsetY is calculated as seven pixels (equivalent to 140 μm). The LsetX can be a positive value and also a negative value.

When the value is positive and the coordinate is displaced into a larger direction of the “x” direction, the value becomes positive, when the coordinate is displayed into a smaller direction thereof, the value becomes negative. In other words, the displaced direction can be known from whether the LsetX is the positive value or the negative value, and an amount of displacement can be known from an absolute value of the LsetX.

As described above, in step S1104, information about the displacement direction and the amount of displacement by which the template region in the first data is displaced into the second direction in the second image data is acquired.

In step S1105, LmaxX, which is the maximum amount of displacement in the second direction, is calculated. The LmaxX refers to the amount of displacement in the second direction when the object is moved in the “y” direction by a detection maximum length Lmax (0.280 mm in this example) between the first image data and the second image data corresponding to the maximum amount of detection estimated by the direct sensor 134.

The LmaxX can be acquired by a following equation (1).

LmaxX=(Lmax/Lset)×LsetX (1)

According to this example,

LmaxX=(0.280 mm/0.140 mm)×0.040 mm=0.080 mm

is calculated. As another calculation method, an angle θ (=arcsin(LsetX/LsetY) between the sensor length direction and the conveyance direction is calculated from the LsetX and the LsetY, and a multiplication of a sine component sine and the detection maximum length Lmax may be acquired. In other words, the LmaxX can be acquired from a following equation (2).

LmaxX=Lmax×arcsin(LsetX/LsetY) (2)

In step S1106, a new template position is re-set in such a manner that, even when the template pattern is moved by the Lmax in the “y” direction, in the “X” direction, the template pattern is not moved out of the region where the image sensor captures the image.

For re-setting of the new template position, the new template position is set so that the template region in the first image data is not located out of a region where the image sensor captures the image in the second direction in the second image. The position of the template region is preferably set in such a manner that the template region in the first image data and the region in the second image corresponding to the template region in the first image data have a symmetrical positional relationship with respect to the center of the imaging plane in the second direction.

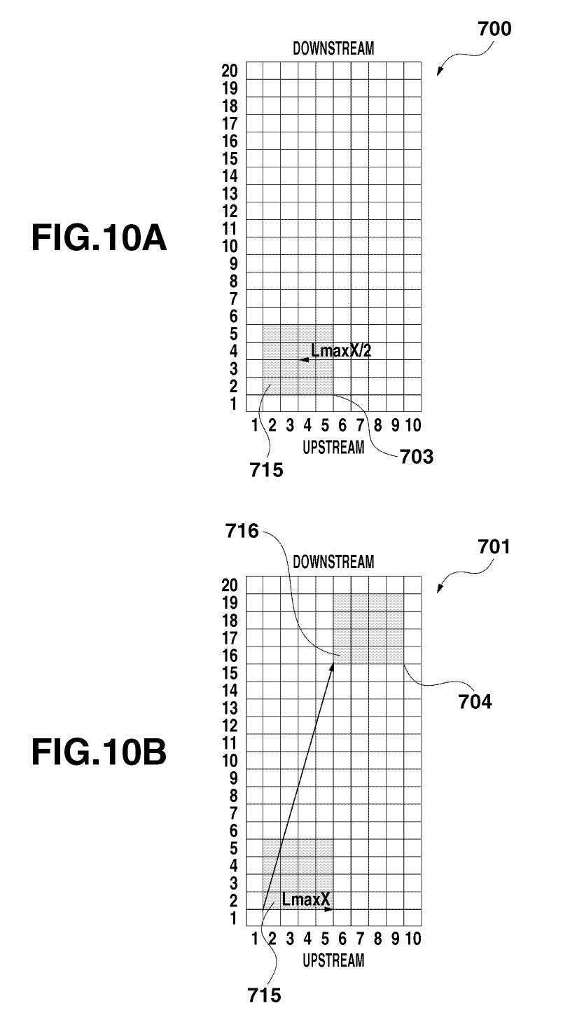

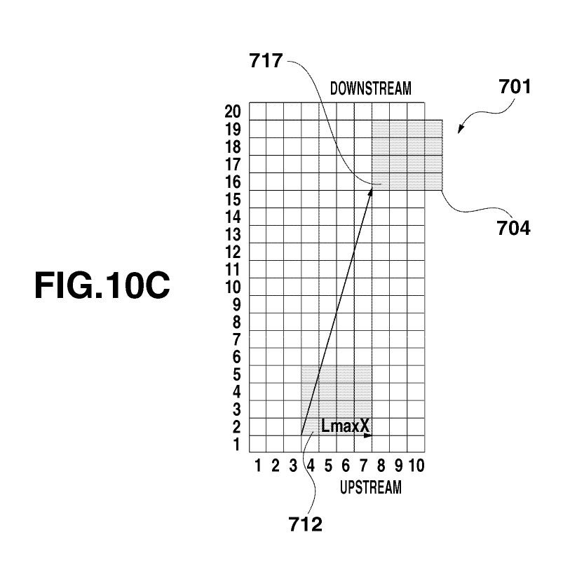

FIG. 10A illustrates the new template position, which is re-set.

A new template position 715 is set at a position, which is shifted by the number of pixels equivalent to a distance LmaxX/2 from the center of the sensor width in the second direction, from the initial template position in the second direction. The shifting direction is an adverse direction to the displacement direction (direction in which the coordinate value is decreased). As described above, the new template pattern 703 is re-set at the position shifted based on the information about the displacement direction and the amount of displacement acquired in step S1104.

The region where the template pattern is clipped based on the acquired displacement information may be set to be changeable in the first direction, at least, in the second direction.

FIG. 10B illustrates the positional relationship in the second image data 701. When maximum conveyance is performed, the new template position 715 is moved to coordinates 716. The region 704 corresponding to the template pattern is not located out of the imaging region, thereby realizing direct sensing with high reliability.

FIG. 10C illustrates a comparison example when the template position is not re-set. When the maximum conveyance is performed, the initial template position 712 is moved to coordinates 717 and a part of the region 704 is moved out of the region where the image sensor captures the image in the second image data 701. After the position of the template region is re-set as described above, image recording is performed by the above-described procedures under the conveyance control.

The calibration operations described above is performed prior to shipping from factories, so that influence of individual differences such as assembly accuracy can be decreased. Further, the calibration operations are regularly or irregularly performed automatically or by user's instructions while the apparatus is used, so that influence of positional displacement caused by changes across the ages can be decreased.

The automatic calibration may be performed every time prior to a start of a recording operation, every time when the predetermined number of print is performed, or every time when the apparatus has been used for predetermined hours. Furthermore, every time when the pattern matching is performed, the above-described processing may be repeatedly performed, so that the position of the template region can be dynamically changed.

If the calibration is performed more frequently, when the relative difference between the directions gradually changes, for example, when the object is obliquely conveyed, the state can be addressed in real time.

According to the present exemplary embodiment, a possibility where the template region set in the first image data is located out of the imaging region in the second image data can be decreased, thereby realizing movement detection with high reliability and stable image recording.

Another exemplary embodiment will be described. The present exemplary embodiment is different from the previous exemplary embodiment in that set-up procedure of the template pattern is different. The present exemplary embodiment is characterized in that a plurality of template patterns are set in the second direction. In the present exemplary embodiment, a direct sensor of a double lens type having two image sensors is used. Other configurations of the entire apparatus are the same as either one of FIG. 1 (an object is a conveyance belt or a medium thereon) or FIG. 2 (the object is the medium).

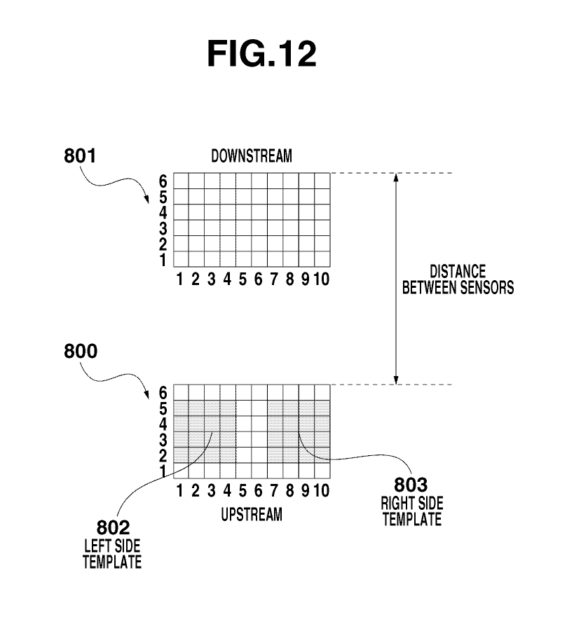

The direct sensor 134 is the double lens type, and the first image sensor and the second image sensor are built therein. Detection regions of the image sensors are separated into two of a first region 800 and a second region 801 as illustrated in FIG. 12. A region between the first region 800 and the second region 801 is a dead region where the detection cannot be performed.

When a detection range of the direct sensor is predetermined, the movement distance of the template pattern is almost predetermined between the first image data and the second image data. Therefore, the detection region may be divided into two small imaging surfaces to cover only necessary regions. Thus, the apparatus can be realized at lower cost than the cost of the apparatus using a single, large image sensor that covers the entire region.

To acquire a large detection range, the single image sensor similar to that used in the previous exemplary embodiment may be used.

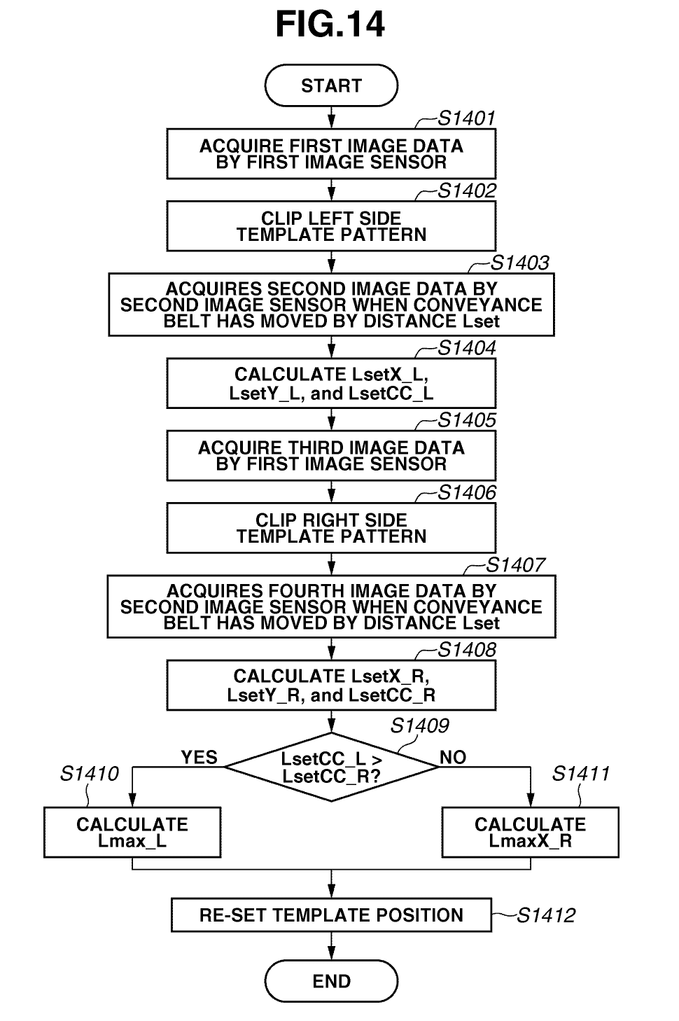

FIG. 14 is a flowchart illustrating a sequence for setting the template position.

In step S1401, while the object is moved at a constant speed, the first image sensor captures the image to acquire the first image data. In step S1402, a left side template pattern 802 is acquired by clipping thereof from the first image data. In this example, the left side template pattern 802 includes four pixels×four pixels and is set at a left end of the first region 800.

In step S1403, the amount of movement of the conveyance belt 205 is monitored by the detection of the encoder 133. When the conveyance belt 205 is conveyed by the distance Lset since the first image data has been acquired, the second image sensor acquires the second image data.

In step S1404, a region having a high correlation with the left side template pattern 802 in the second image data is sought by the image processing. The algorithm is as described with reference to FIG. 7.

As a result of seeking, it is calculated that the left side template pattern 802 is displaced by LsetX_L in the second direction and LsetY_L in the first direction. The displacement direction can be known from whether the LsetX_L is the positive value or the negative. In addition, the amount of the displacement can be known from the absolute value of the LsetX_L.

Further, the maximum value LsetCC_L of the correlation coefficient in correlation processing is stored. The larger the value of LsetCC_L is, the higher the matching degree is.

In step S1405, at the same time when the second image sensor acquires the second image data, the image sensor acquires the third image data (new first image data).

In step S1406, a right side template pattern 803 is acquired by clipping thereof from the third image data. In this example, the right side template pattern 803 includes four pixels×four pixels and is set at a right end of the first region 800.

In step S1407, when the conveyance belt 205 is conveyed by the distance Lset since the third image data has been acquired, the second image sensor acquires fourth image data (new second image data).

In step S1408, a region having a high correlation with the right side template pattern 803 is sought by using the image processing in the fourth image data. As a result of seeking, it is calculated that the right template pattern is displaced by LsetX_R in the second direction and LsetY_R in the first direction. The displacement direction can be known from whether the LsetX_R is the positive value or the negative. In addition, the amount of the displacement can be known from the absolute value of the LsetX_R.

Further, the maximum value LsetCC_R of the correlation coefficient in correlation processing is stored. The larger the value of LsetCC_R is, the higher the matching degree is.

In step S1409, the value of the LsetCC_L is compared with the value of the LsetCC_R, and the result is stored. Since the larger value has the higher correlation of the matching, the larger value is selected. The processing is then branched into step S1410 and step S1411.

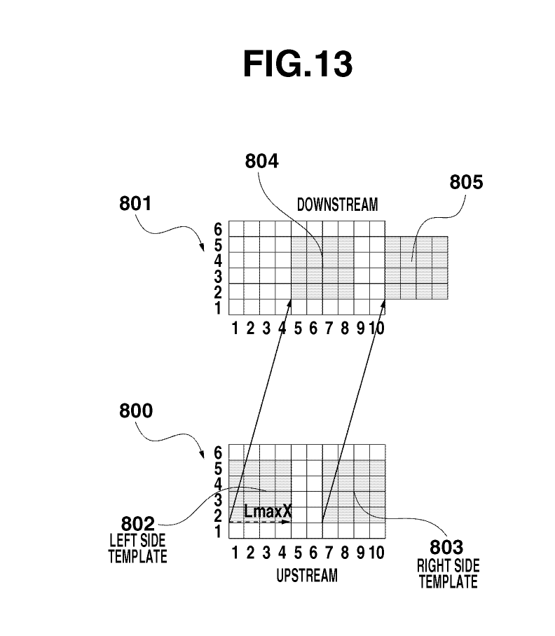

According to an example illustrated in FIG. 13, the left side template pattern 802 is moved to a region 804 in the region 801 where the second image sensor captures the image after the object is moved by Lset. On the other hand, the right side template pattern 803 is moved to a region 805, which is located out of the imaging region 801. In this example, a following expression is satisfied.

LsetCC_L>LsetCC_R

Then, the processing then proceeds to step S1410.

In step S1410, LmaxX_L, which is the maximum amount of displacement thereof in the second direction in the left side template pattern 802, is calculated. The algorithm of calculation is as described in step S1105 with reference to FIG. 11. In step S1411, LmaxX_R, which is the maximum amount of displacement in the second direction thereof in the right side template pattern 803, is calculated.

In step S1408, based on the calculated LsetX_L or LsetX_R, a position of a new template region is re-set not to be located out of the region where the image sensor captures the image in the “x” direction, when the template pattern is moved by Lmax in the “y” direction.

A position of a single template used for actual direct sensing is re-set. More specifically, only when the operation for calibrating the template position is performed, both of right and left templates are temporarily used. Under the conveyance control while the actual recording is performed, similar to the previous exemplary embodiment, one template pattern is used to perform the pattern matching.

Upon completing the re-set of the template position, the image recording is performed by the above-described procedure under the conveyance control.

As described above, according to the present exemplary embodiment, a plurality of template regions are set in the second direction, the image processing is performed on the respective template regions, the region where the higher correlation coefficient can be acquired is selected, and then the template region is re-set.

According to the above-described exemplary embodiments, an example in which the object is the conveyance belt is mainly described. However, the medium that is conveyed by the driving roller may be used as the object as illustrated in FIG. 2. In this case, instead of the group of markers formed on the conveyance belt, the microscopic patterns on the surface of the medium are used to acquire the movement state by the image processing.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-250828 filed Oct. 30, 2009, which is hereby incorporated by reference herein in its entirety.

What is claimed is:

1. An apparatus comprising:
a sensor configured to capture an image of a surface of an object that moves in a predetermined direction and acquire first and second data; and
a processing unit configured to acquire a movement state of the object by clipping a template pattern in a template region set in the first data and seeking a region having a correlation with the template pattern in the second data,
wherein the processing unit acquires displacement information about a displacement of the template region in the first data that is displaced in the second data in a first direction and in a second direction crossing to the first direction corresponding to the predetermined direction on image coordinates, and based on the acquired displacement information, a position of the template region is set in the second direction.

2. The apparatus according to claim 1, wherein the processing unit acquires an amount of movement in the first direction, a displacement direction and an amount of displacement in the second direction as information about the displacement, and based on the acquired information, the template region is re-set.

3. The apparatus according to claim 1, wherein the processing unit re-sets the template region by setting a plurality of template regions in the second direction, performing image processing on respective template regions, and selecting a region having a higher correlation coefficient.

4. The apparatus according to claim 1, wherein the processing unit sets the template region so that a region at which the template pattern in the first data is clipped is located in a region that is not out of the second data in the second direction.

5. The apparatus according to claim 4,
wherein the processing unit sets the template region so that the template region in the first data and the region in the second data corresponding to the template region have a symmetrical positional relationship with respect to a center of an imaging plane in the second direction.

6. The apparatus according to claim 1,
wherein the processing unit re-sets the template region as calibration.

7. The apparatus according to claim 1, further comprising a mechanism for moving a medium or a conveyance belt, wherein the object is the medium or the conveyance belt for mounting and conveying the medium.

8. The apparatus according to claim 7, further comprising a control unit configured to, based on a movement state of the conveyance belt or the medium, control driving of the mechanism.

9. The apparatus according to claim 8, further comprising an encoder configured to detect a rotation state of a driving roller included in the mechanism, wherein the control unit, based on the rotation state and the acquired movement state, controls driving of the driving roller.

10. A recording apparatus comprising the apparatus according to claim 1, and a recording unit that performs recording on the moving medium.

11. A method comprising:
capturing an image of a surface of an object that moves in a predetermined direction, and acquiring first and second data; and
acquiring a movement state of the object by clipping a template pattern in a template region set in the first data, and seeking a region having a correlation with the template pattern in the second data by using image processing,
wherein displacement information about the displacement of the template region in the first data that is displaced in the second data in a second direction crossing a first direction corresponding to the predetermined direction on image coordinates is acquired, and based on the acquired displacement information, a position of the template region is set in the second direction.

12. The method according to claim 11, further comprising acquiring an amount of movement in the first direction, a displacement direction and an amount of displacement in the second direction as information about the displacement, and based on the acquired information, re-setting the template region.

13. The method according to claim 11, further comprising re-setting the template region by setting a plurality of template regions in the second direction, performing image processing on respective template regions, and selecting a region having a higher correlation coefficient.

14. The method according to claim 11, further comprising setting the template region so that a region at which the template pattern in the first data is clipped is located in a region that is not out of the second data in the second direction.

15. The method according to claim 14, further comprising setting the template region so that the template region in the first data and the region in the second data corresponding to the template region have a symmetrical positional relationship with respect to a center of an imaging plane in the second direction.

16. The method according to claim 11, further comprising re-setting the template region as calibration.

17. The method according to claim 11, further comprising moving a medium or a conveyance belt by a mechanism, wherein the object is the medium or the conveyance belt for mounting and conveying the medium.

18. The method according to claim 17, further comprising controlling driving of the mechanism based on a movement state of the conveyance belt or the medium.

19. The method according to claim 18, further comprising detecting a rotation state of a driving roller included in the mechanism; and controlling driving of the driving roller based on the rotation state and the acquired movement state.

20. The method according to claim 11, further comprising performing recording on the moving medium.
